(19) United States
(12) Patent Application Publication
(10) Pub. No.: US 2004/0107406 A1
(43) Pub. Date: Jun. 3, 2004

(54) Text string checking

(76) Inventor: Daniel Fallman, Umea (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/417,328

(22) Filed: Apr. 17, 2003

(30) Foreign Application Priority Data
Apr. 18, 2002 (SE) SE 0201177-3

(51) Int. Cl. G06F 17/21

(52) U.S. Cl. 715/530

(57) ABSTRACT

The present invention relates to a method and to a system for checking a text string (1), wherein the text string is checked against a database (2), which includes both words (21) and phrases (22). It is proposed in particular that the database is comprised of the global network Internet (A) with its associated home pages (A1, A2, A3, An) and text masses. Checked text strings are delivered as an argument (3) to at least one search engine (4) which then searches for the text string on the Internet (A). The search result (41) from the search engine (4) is received by an evaluating unit (5), which presents an evaluation (51) of the text string (1) based on the search result (41).

### TECHNICAL FIELD

The present invention relates to a method and to a system for checking text strings, where the text string is checked against a database that includes both individual words and phrases. The present invention also relates to computer program products and to a computer readable medium on which a computer program code is stored, thereby enabling an inventive method or an inventive system to be implemented.

### DESCRIPTION OF THE BACKGROUND ART

It is known to use correct spelling functions in different word processing programs and other computer based applications. These are often based on a locally stored word list.

It is also known for the text written to be checked grammatically at least to some extent. Such checks are based on models of how a sentence should be constructed grammatically.

Such word lists and models are statistic, since they are stored locally and are seldom updated. Moreover, a traditional spelling check gives no evaluation of a word, but merely whether or not a word exists according to the word list or the database used.

Patent Publication U.S. Pat. No. 5,970,492 teaches a system in which several users are able to share their respective word lists with one another, and where a common word list can be updated and used by respective users. Communication between respective users and the common word list is effected via the Internet. This publication describes a system that affords the advantage of enabling a plurality of users to update a common word list.

### SUMMARY OF THE PRESENT INVENTION

Technical Problems

When considering the earlier standpoint of techniques as described above, it will be seen that a technical problem resides in the provision of a correct spelling function or a text checking function in which attention is paid to unusual words, such as technical terms or slang words/expressions.

Another technical problem resides in the ability to take into consideration expressions that while being grammatically incorrect are nevertheless acceptable in some circumstances, for instance in respect of colloquial expressions, old-fashioned language, proverbs, adages, maxims, sayings or technical language.

Another technical problem resides in including an evaluation of a word, for example the normal frequency in which a word is used or whether the word is purely informative or has an esoteric meaning.

Another technical problem resides in enabling a database to cover all occurring words in carrying out spelling checks.

A technical problem thus resides in the ability to reflect a living, dynamic language and the daily use of a language in a static locally stored wordlist and a compilation of grammatical rules.

Solution

On the basis of a text string checking method or text string checking system in which the text string is checked against a database that includes both individual words and phrases, it is proposed in accordance with the present invention that the database is comprised of the global network Internet with its associated home pages and text masses. As a result, the database used will reflect the language usage concerned, including slang expressions and various accepted methods of expression.

With the intention of making available this large volume of words and text, it is proposed in accordance with the present invention that the text string is delivered as an argument to at least one search engine, which searches for this text string on the Internet. The search result from said search engine is received by an evaluating unit, which presents an evaluation of the text string on the basis of the search result.

In order to enable a comparison to be made between different expressions, it is proposed in accordance with the present invention that it is possible to check two or more text strings in parallel. In this case, the evaluating unit may be adapted to weight the search results obtained from the search engine in respect of respective text strings in accordance with the number of search hits achieved with regard to respective text strings.

In order to provide a check that may be relevant to a given application, such as a given technical field, a given geographical area or a given time period, it is proposed in accordance with the present invention that the argument includes a category determination according to a categorisation used by the search engine.

Such a category determination may then include one or more different categories, for example:

time, such as a search carried out solely in material from a specified time period;

domain, such as a search carried out solely in material from the domain name within given top domains;

topic, such context definers that define a topic more or less generally, for instance outdoor life, fishing or fishing rod.

The present invention also enables a grammatical check to be carried out, or a check to ascertain how a word is used in a context, by allowing the text string to contain not only one word but also a phrase that contains several words if such is required.

An inventive method can be used either as a separate or free-standing application or can be implemented as a tool in some other application.

For example, a text string can be marked in some way in a selected application, whereafter a check is activated by means of a specific command. When several text strings are to be checked in parallel, one or more text strings can then be entered manually.

The checking procedure may also be available as an inbuilt tool in an application, such as a word processor, a spreadsheet or calculating program, a drawing program, or some other application in which text is processed in some way.

According to one preferred embodiment of the invention, one of the evaluated text strings can be chosen as a replacement for the marked text string.

A text string can be evaluated in different ways. One simple way is to allow evaluation of the number of occurrences of a text string.

It is also possible to allow the search result and the evaluation to be stored as a reference in a locally active database.

The present invention can also be implemented as a system that includes a client and a server.

The client will then carry out the local measures included in the inventive method, in other words fetch the text string, compile an argument, send the argument as a request/enquiry, and evaluate the received search result.

The server carries out the network-based measures in accordance with the inventive method, for example receives the argument from a client, sends the argument to one or more search engines, receives the result/results from the search engine/search engines and sends the result/results to the client. It lies within the concept of the invention to adapt such a server for co-action with a plurality of different clients.

The present invention may also be implemented through the medium of one or more computer program products or a computer readable medium that includes a computer program code which, when executed, results in the co-action of one or more computers such as to carry out the inventive method or to build the inventive system.

Advantages

Those advantages primarily associated with a method, a system, computer program products or a computer readable medium in accordance with the present invention reside in the possibility of checking against the Internet words or phrases that reflect a living, dynamic and multifaceted use of a language.

This reflection of the language shows different usages of words and phrases. The Internet also shows alternative spellings of words, and also slang expressions used in the living language.

The database Internet is updated continuously.

Instead of relying upon a static word list, the present invention offers a database that handles unusual words that may occur, for instance, in dialectal expressions, proverbs, colloquialisms, names and slang.

The present invention not only allows a word or a phrase to be checked against how a language should be, but also how the living language actually is.

### BRIEF DESCRIPTION OF THE DRAWINGS

A method, a system, computer program products and a computer readable medium having features significant of the present invention will now be described in more detail by way of example with reference to the accompanying drawings, in which

FIG. 1 is a highly simplified schematic illustration of a text string checking method according to the present invention;

FIG. 2 is a schematic illustration of a method of checking several parallel text strings;

FIG. 3 illustrates schematically how the present invention can be implemented as a part of another application;

FIG. 4 is a highly simplified schematic illustration of a text string checking system according to the present invention;

FIG. 5 is a schematic illustration of a system for checking several parallel text strings; and

FIG. 6 is a schematic illustration of computer program products and a computer readable medium in accordance with the present invention.

### DESCRIPTION OF EMBODIMENTS AT PRESENT PREFERRED

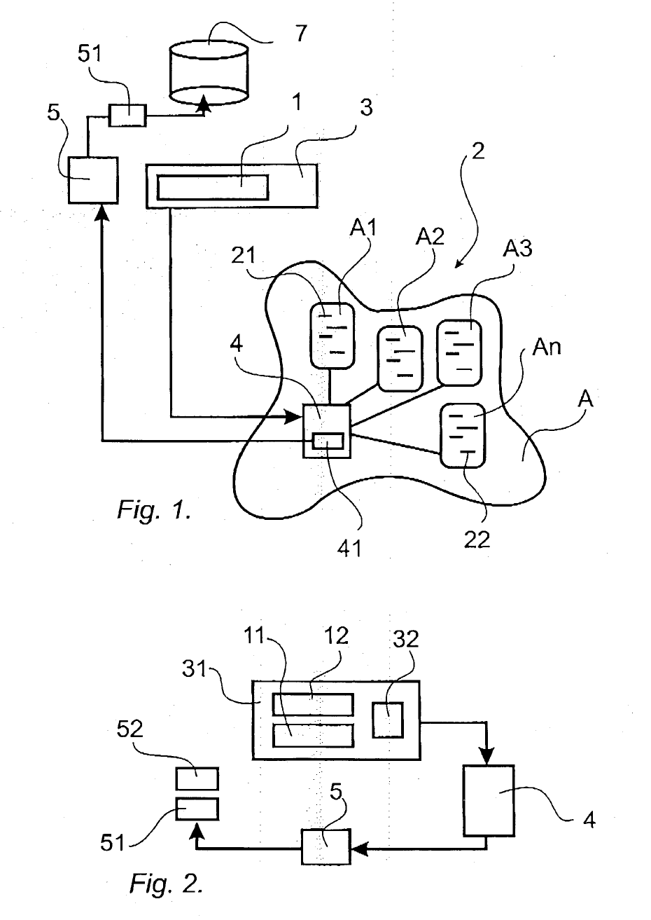

Illustrated in FIG. 1 is a method for checking a text string 1 against a database 2, which includes both individual words 21 and phrases 22.

The check is carried out by comparing the text string 1 with words 21 and phrases 22 found in the database 2.

According to known technology, the absence of the text string indicates that a word included in the string is spelled wrongly or is not found, or when the text string includes several words that form an expression that the expression is in error, such as grammatically wrong.

It is particularly proposed in accordance with the present invention that the database 2 is comprised of the global network Internet A with associated home pages A1, A2, A3, . . . An, and the text masses found on these pages.

FIG. 1 shows schematically that the text string 1 is sent as an argument 3 to at least one search engine 4 that searches for the text string 1 on the Internet A. It will be understood that there is nothing to prevent two or more search engines being used in the inventive method or the inventive system. However, for the sake of simplicity only the use of one search engine is shown in the figures and described in the following description with regard to both method and system.

The search engine 4 returns a search result 41, which is received by an evaluating unit 5 that presents an evaluation 51 of the text string 1 based on the search result 41.

FIG. 2 shows that the argument 31 can include two or more text strings 11, 12 which can be checked in parallel, and that the evaluating unit 5 weights the search results 42, 43 obtained from the search engine 4 with regard to respective text strings 11, 12 in accordance with the number of search hits achieved for respective text strings.

For example, it is possible to compare two alternative spellings of a word, such as the words “colour” and “color”, or “hippo” and “hippopotamus”. The first comparison may show the usual frequency of different spellings of one and the same word, whereas the latter comparison may show the normal or typical frequency of different ways of expressing one and the same word, where the word “hippo” is an abbreviation and possibly a more everyday designation of “hippopotamus”.

It may be desirable to limit the search made by the search engine 4 on the Internet. For example, the argument 31 may include to this end a category determination 32 according to one of the categorisations used by the search engine 4, as shown in FIG. 2. It will be understood that such a category determination can be used even if the argument 31 includes only one text string.

This category determination 32 may include one or more different categories whereby a search can be limited. A category determination may, for instance, include the categories:

time, where a search is carried out solely in material from a specified time period;

domain, where a search is carried out solely in material from the domain name within given top domains;

topics, such as context definers that define a topic more or less generally, such as outdoor life, fishing, or fishing rods.

With the intention of enabling both individual words and phrases to be checked, it is proposed in accordance with the present invention that the text string 1 may include either one word or a phrase that contains several words.

In addition to showing whether or not a phrase exists, the comparison of phrases can also show which phrase is most correct in respect of a given context. Using the above words “hippo” and “hippopotamus” as an example, it will be understood that it may be difficult for a person whose native language is other than the English language to know when one expression shall be used in preference to the other. For instance, the two phrases “a hippo is a large animal” and “a hippopotamus is a large animal” can be compared with one another. The words in both phrases/sentences are spelled correctly and the phrases are grammatically correct, meaning that a traditional correct spelling program would be of no help. However, a method according to the present invention will show that the sentence “a hippopotamus is a large animal” is more usual than the sentence “a hippo is a large animal”, which can be interpreted as meaning that the word “hippopotamus” is more formal than the word “hippo”, therewith giving the user an indication of how the words shall be used.

This is a simple example used to illustrate possible use of the present invention. The practical application may require more comparisons of the use of a word in different connections in order to obtain sufficient basis for an interpretation or evaluation of the word.

An inventive method can be implemented in different ways.

According to one preferred embodiment, the inventive method is implemented by marking the text string 1 in some way in a selected application, and then initialising the checking procedure with the aid of a specific command. For example, a double click can be made on a text string and thereafter a right-hand click can be made on the marked text string to initialise the checking procedure. The checking procedure may also be initialised by depressing a key combination subsequent to having marked a text string. This key combination may be made unique, so as to prevent the checking procedure being initialised unintentionally when a text string is marked.

When several text strings shall be checked in parallel, one or more text strings may be entered manually subsequent to having marked the first text string and having initialised the check.

This implementation enables any text string to be checked from any application whatsoever where text is processed and where a check according to the present invention may be of interest.

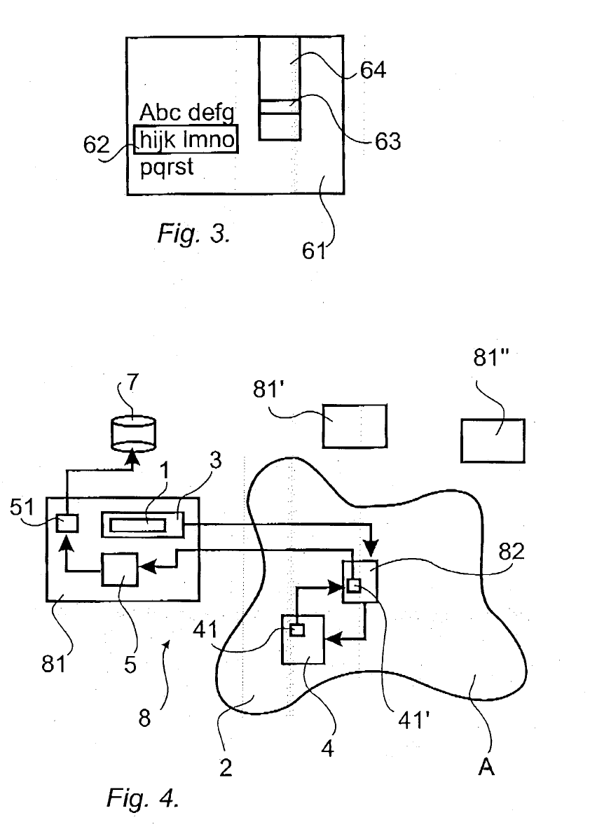

According to another preferred embodiment of the present invention, illustrated schematically in FIG. 3, the check is implemented as an available tool incorporated in an application 6, such as a word processor, a spread sheet or calculating program, a drawing program, or some other application, where text 61 is processed or handled in some way. According to this embodiment, a marked text string 62 is available for checking, for instance through the medium of a selection 63 from a menu 64 active in the application 6, or by a short command active in said application.

When several text strings are checked in parallel, one of the text strings can be chosen as a replacement for the text string originally marked when it is found that another text string is more suitable or appropriate than the one used, regardless of the embodiment applied in accordance with the present invention.

Referring back to FIG. 2, it will be seen that the evaluating unit 5 executes an evaluation 52, 53 comprised of the number of occurrences of respective text strings 11, 12 according to the result 41 from the search engine 4.

It will also be seen that the search result 41 including the evaluation 51 can be stored as a reference in a local database 7.

The present invention also relates to a system 8, which is explained and illustrated in FIG. 4. Those reference signs used to identify components that are common with the inventive method are used in FIG. 4 and also in the following description referring to said figure.

The system 8 is thus adapted for checking a text string 1, where the text string 1 can be checked against a database 2 that includes both words and phrases.

The system 8 includes a client 81 and a server 82.

The client 81 is adapted to act locally and to fetch the text string 1 from this location. The client 81 is also adapted to send the text string 1 to the server 82 as an argument 3.

The server 82 is adapted to act centrally, and to send the argument 3 to at least one search engine 4 adapted to operate in the global network Internet A with associated home pages and text masses.

The search engine A is adapted to search for the text string on the Internet in accordance with known techniques, and the server 82 is adapted to receive a search result 41 from the search engine 4, and the client 81 is adapted to receive the search result 41′ from the server 82.

The client 81 includes an evaluating unit 5 which is adapted to present locally an evaluation 51 of the text string 1 based on the search result 41′.

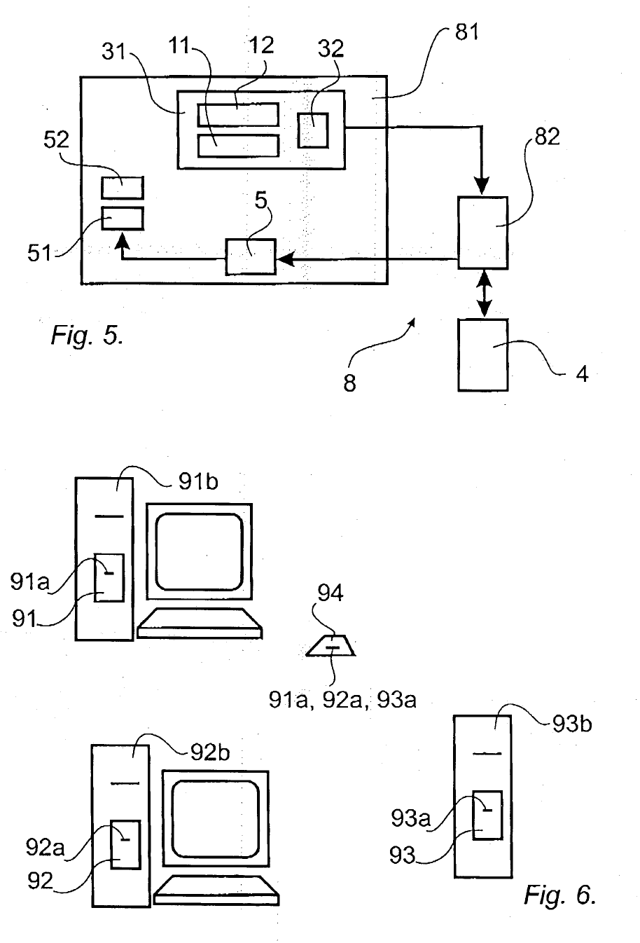

As will be seen from FIG. 5, the system 8 may be adapted to check two or more text strings 11, 12 in parallel, wherein the evaluating unit 5 is then adapted to weight the search results obtained from the server 82 for respective text strings in accordance with the number of search hits achieved with regard to respective text strings 11, 12.

According to one preferred embodiment of the present invention, the client 81 may be adapted to allow the argument 31 to include a category determination 32 in accordance with a categorisation used by the search engine 4.

The client 81 may be adapted to allow the category determination 32 to include one or more different categories, for instance:

time, where a search is carried out solely in material from a specified time period;

domain, where a search is carried out solely in material from the domain name within given top domains;

topics, such as context definers that define a topic more or less generally, such as outdoor life, fishing, or fishing rods.

It is also proposed in accordance with the present invention that the client 81 is adapted to allow the text string 1 to include one word or a phrase that contains several words.

An inventive system can be implemented in various ways. According to one preferred embodiment of the invention, the system is implemented by enabling the client 81 to be activated through a first command when a text string 1 has been marked in some way in a selected application, and, when several text strings 11, 12 are to be checked in parallel, to allow the client 81 to permit manual infeed of one or more further text strings. The client 81 is adapted to thereafter compile the argument 3, 31 and to send the argument to the server 82 in accordance with a given second command.

According to an alternative embodiment, the system is implemented by virtue of the check being available as a tool incorporated in an application 6, such as in a word processor, a spread sheet or calculating program, a drawing program, or some other application adapted to process text 61 in some way or another.

The client 81 is adapted to allow one of the text strings to replace the marked text string in accordance with a third command, regardless of the embodiment applied.

The evaluating unit 5 may be adapted to allow the evaluation 52, 53 to be based on the number of occurrences of respective text strings 11, 12.

Referring back to FIG. 4, it will be seen that the system 8 includes a local database 7, and that the client 81 may be adapted to store the search result 41′ together with the evaluation 51 as a reference in said local database 7.

According to the present invention, the server 82 is adapted to co-operate with a number of different locally active clients 81, 81′, 81″.

For a deeper understanding of the inventive system, reference is made to the earlier described method, which is slightly more detailed in certain passages. Thus, the system of the inventive system has not been described in such detail as the description of the method, so as to avoid overloading the present description with repeated or redundant text masses.

FIG. 6 is intended to illustrate a first computer program product 91 that includes a first computer program code 91a which, when executed by a first computer unit 91b, causes said computer unit to carry out a check in accordance with the inventive method.

The present invention also relates to a second computer program product 92 that includes a second computer program code 92a which, when executed by a second computer unit 92b, causes said computer unit to operate as a client 81 in accordance with the inventive system 8.

The present invention also relates to a third computer program product 93 that includes a third computer program code 93a which, when executed by a third computer unit 93b, causes said computer unit to operate as a server 82 in accordance with the inventive system 8.

The present invention also includes a computer readable medium 94, illustrated schematically as a diskette in the figure, on which computer program codes 91a, 92a, 93a, according to the first, second or third computer products 92, 92, 93 are stored.

It will be understood that the invention is not restricted to the aforedescribed exemplifying embodiments thereof and that modifications can be made within the scope of the inventive concept as illustrated in the accompanying Claims.

1. A text string checking method in which the text string is checked against a database that includes both words and phrases, characterised in that said database is comprised of the global network Internet and associated home pages and text masses; in that said text string is delivered as an argument to at least one search engine that searches for said text string on the Internet; in that the search result from the search engine is received by an evaluating unit; and in that said evaluating unit presents an evaluation of said text string based on said search result.

2. A method according to claim 1, characterised by checking two or more text strings in parallel; and by causing said evaluating unit to weight the search results obtained from the search engine for respective text strings in accordance with the number of search hits achieved for respective text strings.

3. A method according to claim 1 or 2, characterised in that said argument includes a category determination according to one of the categorisations used by said search engine.

4. A method according to claim 3, characterised in that said category determination includes one or more different categories, for instance
time, where a search is carried out solely in material from a specified time period;
domain, where a search is carried out solely in material from the domain name within given top domains;
topics, such as context definers that define a topic more or less generally, such as outdoor life, fishing, or fishing rods.

5. A method according to any one of the preceding claims, characterised in that said text string includes one word or a phrase that contains several words.

6. A method according to any one of the preceding claims, characterised in that the text string is marked in some way in a selected application; in that the checking procedure is then activated by a specific command; and in that, when several text strings are checked in parallel, one or more text strings can be entered manually.

7. A method according to any one of the preceding claims, characterised in that said checking procedure is available as a tool incorporated in an application, such as a word processor, a spread sheet or calculating program, a drawing program, or some other application in which text is processed in some way.

8. A method according to claim 6 or 7, characterised in that in that one of said text strings can be chosen as a replacement for said marked text string.

9. A method according to any one of the preceding claims, characterised in that said evaluation is comprised of the number of occurrences of respective text strings.

10. A method according to any one of the preceding claims, characterised in that said search result and said evaluation are stored as a reference in a local database.

11. A text string checking system in which said text string can be checked against a database that includes both words and phrases, characterised in that the system includes a client and a server; in that the client is adapted to act locally and there fetch said text string; in that the client is adapted to send the text string as an argument to said server, which is adapted to operate centrally; in that the server is adapted to send said argument to at least one search engine that is adapted to operate in the global network Internet with its associated home pages and text masses; in that the search engine is adapted to search for the text string on the Internet; in that said server is adapted to receive a search result from the search engine; in that the client is adapted to receive said search result from said server; and in that the client includes an evaluating unit which is adapted to present locally an evaluation of said text string based on said search result.

12. A system according to claim 11, characterised in that the system is adapted to check two or more text strings in parallel; and in that the evaluating unit is adapted to weight the search results obtained from said server or respective text strings in accordance with the number of search hits achieved for respective text strings.

13. A system according to claim 11 or 12, characterised in that the client is adapted to allow said argument to include a category determination according to one of the categories used by the search engine.

14. A system according to claim 13, characterised in that the client is adapted to allow said category determination to include one or more different categories, for example:
time, where a search is carried out solely in material from a specified time period;
domain, where a search is carried out solely in material from the domain name within given top domains;
topics, such as context definers that define a topic more or less generally, such as outdoor life, fishing, or fishing rod.

15. A system according to any one of claims 1 1 to 14, characterised in that the client is adapted to allow said text string to include one word or a phrase that contains several words.

16. A system according to any one of claims 11 to 15, characterised in that when a text string has been marked in some way in respect of a chosen application, the client can be activated through a first command; in that when several text strings are checked in parallel, the client is able to permit manual entry of one or more further text strings; and in that said client is thereafter able to compile said argument and to send it to the server in accordance with a given second command.

17. A system according to any one of claims 11 to 16, characterised in that said checking procedure is available as a tool incorporated in an application, such as a word processor, a spread sheet or calculating program, a drawing program, or some other application adapted to process text in some way.

18. A system according to claim 16 or 17, characterised in that said client is adapted to allow one of said text strings to replace said marked text string, in accordance with a third command.

19. A system according to any one of claims 11 to 18, characterised in that the evaluating unit is adapted to allow the evaluation to consist of the number of occurrences of respective text strings.

20. A system according to any one of claims 11 to 19, characterised in that the system includes a local database; and in that the client is adapted to store said search result together with said evaluation as a reference in said local database.

21. A system according to any one of claims 11 to 20, characterised in that said server is adapted to co-operate with a plurality of different locally acting clients.

22. A first computer program product, characterised in that the first computer program product includes a first computer program code which, when executed by a first computer unit, causes the first computer unit to carry out a check in accordance with any one of claims 1 to 10.

23. A second computer program product, characterised in that the second computer program product includes a second computer program code which, when executed by a second computer unit, causes said second computer unit to act as a client in accordance with any one of claims 11 to 21.

24. A third computer program product, characterised in that the third computer program product includes a third computer program code which, when executed by a third computer unit, causes said third computer unit to act as a server in accordance with any one of claims 11 to 21.

25. A computer readable medium, characterised in that said computer readable medium has stored therein a computer program code according to any one of claims 22 to 24.
